(19) United States
(12) Patent Application Publication
(10) Pub. No.: US 2013/0342053 A1
(43) Pub. Date: Dec. 26, 2013

(54) Rotor of Brushless Motor and Brushless Motor Using the Same

(71) Applicant: Georges A.M. Van Gansen, Tsuen Wan (HK)

(72) Inventor: Georges A.M. Van Gansen, Tsuen Wan (HK)

(21) Appl. No.: 13/531,813

(22) Filed: Jun. 25, 2012

(51) Int. Cl. H02K 5/18

(52) U.S. Cl. 310/64

(57) ABSTRACT

The present invention relates to a brushless motor and especially to a rotor of brushless motor. The rotor of brushless motor includes a front cover, a cylindrical casing and a magnet adhered to the inner face of the cylindrical casing. The cylindrical casing is provided with some grooves on its outside surface. The present invention has made the best of the outside surface of the cylindrical casing of the rotor. In this case, an excellent heat dissipating effect can be achieved without changing the structure of the motor since the flow rate of air and the heat dissipating contact area between the air and the rotor is improved during the rotation.

### FIELD OF THE INVENTION

The present invention relates to the technical field of brushless motor, and especially to a rotor of brushless motor.

### BACKGROUND OF THE INVENTION

Brushless motor is one kind of engine widely applied in the field of radio-controlled model. The brushless motor becomes more and more popular since it is nearly free from wearing and opening maintenance during its lifetime and it is high in efficiency. The existing brushless motor comprises a rotor, a stator and a rotating shaft. Specifically, the rotor is mainly comprised of a magnet and a casing, wherein the magnet is adhered to the inner surface of the casing by glue and the outside surface of the casing is smooth. During operation, the brushless motor usually produces much heat. In the prior art, circumferential holes are arranged in the front and rear covers of the motor to achieve heat dissipation. However, the heat dissipating efficiency is not enough.

### SUMMARY OF THE INVENTION

The objective of the present invention is to provide a brushless motor and a rotor with a groove on the outside surface of its casing, aiming at the problem that the heat dissipating efficiency is not enough in the prior art.

According to an aspect, a rotor of brushless motor is provided, which includes a front cover, a cylindrical casing and a magnet adhered to the inner surface of the cylindrical casing; wherein the cylindrical casing is provided with some grooves on its outside surface.

In the rotor of brushless motor of the present invention, the grooves include the ones extending in the circumferential direction of the cylindrical casing.

In the rotor of brushless motor of the present invention, the sectional shapes of the grooves in the axial direction of the cylindrical casing include triangle, trapezium or rectangle.

In the rotor of brushless motor of the present invention, the grooves include some continuous helical ones and some separated annular ones.

According to another invention, a brushless motor is provided, which includes a rotor, a stator and a rotating shaft; wherein the rotor includes a front cover, a cylindrical casing and a magnet adhered to the inner surface of the cylindrical casing; the stator comprises silicon steel sheets and a rear cover, and the cylindrical casing of the rotor is provided with some grooves on its outside surface.

In the brushless motor of the present invention, the grooves include the ones extending in the circumferential direction of the cylindrical casing.

In the brushless motor of the present invention, the sectional shapes of the grooves in the axial direction of the cylindrical casing include triangle, trapezium or rectangle.

In the brushless motor of the present invention, the grooves include some continuous helical ones and some separated annular ones.

When implementing the present invention, the following advantageous effects can be achieved: this invention has made the best of the outside surface of the casing of the rotor; in this case, an excellent heat dissipating effect can be achieved without changing the structure of the motor since the flow rate of air and the contact area for heat dissipation between the air and the rotor is improved during the rotation.

### BRIEF DESCRIPTION OF THE DRAWINGS

The present invention will be further described with reference to the accompanying drawings and embodiments. In the figures:

FIG. 1 is a schematic diagram for the brushless motor in an embodiment of the present invention;

FIG. 2 is a schematic diagram for the cylindrical casing in a first embodiment of the present invention;

FIG. 3 is a schematic diagram for the cylindrical casing in a second embodiment of the present invention;

### REFERENCE SIGNS

1 cylindrical casing
2 front cover
3 rear cover
4 rotating shaft

### DETAILED DESCRIPTION OF THE PREFERRED EMBODIMENT

These and other advantages, aspects and novel features of the present invention, as well as details of an illustrated embodiment thereof, will be more fully understood from the following description and drawings, while various embodiments of the present invention have been presented by way of example only and not limitation.

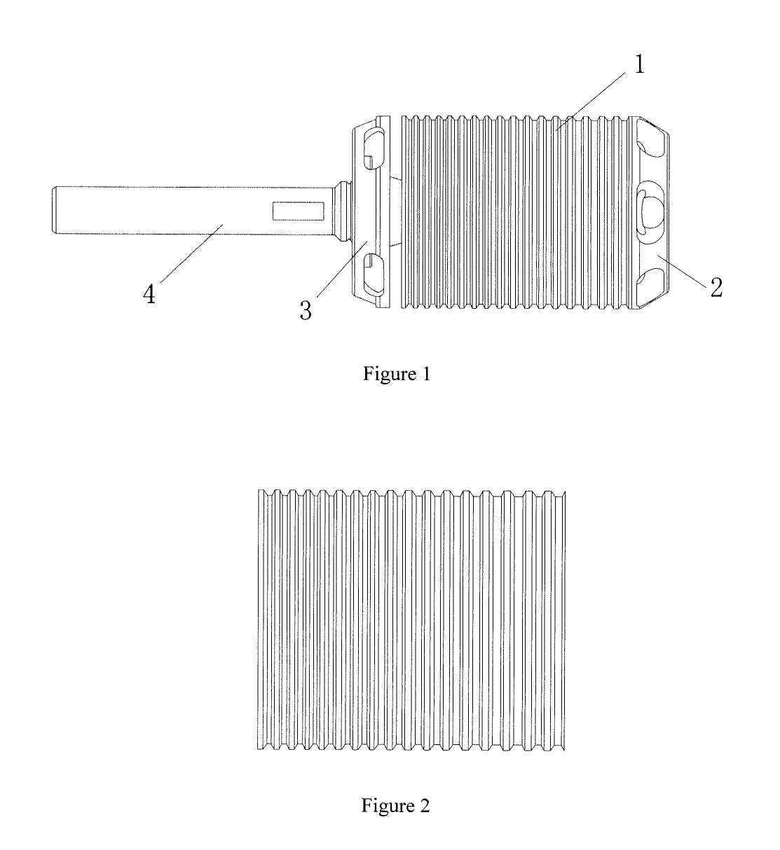

A first embodiment of the brushless motor is shown in FIGS. 1-2. Referring to these two figures, a brushless motor with a rotor is provided, wherein the outside surface of a casing of the rotor is arranged with a trapezoidal sectional shape. The brushless motor includes a rotor, a stator and a rotating shaft. The rotor includes a front cover 2 of the brushless motor, a cylindrical casing 1 and a magnet adhered to the inner surface of the cylindrical casing, and the stator includes some silicon steel sheets and a rear cover 3 of the brushless motor.

The magnet of the rotor is adhered to the inner surface of the cylindrical casing 1 by 638 glue and epoxy glue, and the front cover 2 of the brushless motor and the cylindrical casing 1 are fixed with respect to each other through threaded connection and 638 glue. The front cover 2 of the brushless motor are arranged with fabrication holes for heat dissipation in its circumferential direction. The outside surface of the cylindrical casing 1 is disposed with some separated annular grooves extending in the circumferential direction of the cylindrical casing 1. The sectional shape of the groove in the axial direction of the cylindrical casing 1 is trapezium.

The stator includes silicon steel sheets and a rear cover 3 of the brushless motor, the two of which are fixed with each other by epoxy glue. As same as the front cover 2, the rear cover 3 of the brushless motor is also provided with some fabrication holes for heat dissipation in its circumferential direction. Furthermore, it is provided with one bearing hole at its center.

The rotating shaft 4 of the brushless motor passes through the bearing hole of the rear cover 3 of the brushless motor. The rotating shaft 4 is in threaded connection with the front cover 2 of the brushless motor so that the rotor and the stator are connected together.

In this embodiment, the separated annular grooves with the trapezoidal cross section are arranged on the surface of the cylindrical casing 1 in the circumferential direction of the cylindrical casing 1. When the rotor rotates at high speed under the propelling of the rotating shaft 4 of the brushless motor, the air will flow at high speed in the trapezoidal grooves on the surface of the cylindrical casing 1. In this way, the contact area between the air and the cylindrical casing 1 increases greatly so as to promote the heat dissipation produced by the operation of the motor. Besides, the fabrication holes for heat dissipation of the front and rear covers 2 and 3 of the brushless motor further promote the heat dissipating effect.

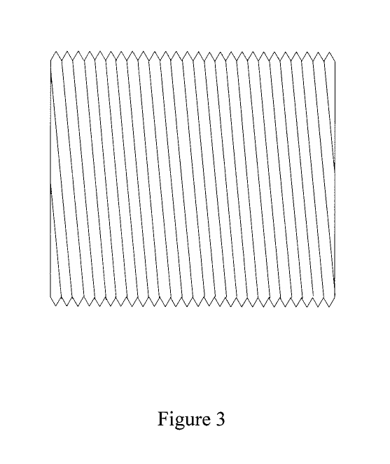

In a second embodiment of the present invention, in order to promote the flow of the air around the cylindrical casing 1, the heat dissipating grooves on the outside surface of the cylindrical casing 1 is set in a shape of helical form in the circumferential direction of the cylindrical casing; that is, the heat dissipating grooves present as continuous helical ones. Moreover, as shown in FIG. 3, the sectional shape of the heat dissipating grooves in the axial direction of the cylindrical casing is designed as triangle. This kind of groove not only increases the flow speed of the air but also increases the contact area between the air and the cylindrical casing 1 so as to accelerate the heat dissipation.

In the two embodiments above, the sectional shapes of the grooves in the axial direction of the cylindrical casing can also be rectangle, and the layout (continuous helical or separated annular) of such grooves can be combined with its sectional shape randomly.

It should be noted that the present invention is described by some embodiments. Those skills in the art understand that various modifications or equivalents can be performed on these features and embodiments without departing from the spirit and scope of the present invention. Moreover, under the teaching of the present invention, these features and embodiments can be modified so as to adapt some specific situations and materials without departing from the spirit and scope of the present invention. Therefore, the present invention should not be limited by the specific embodiments disclosed herein. All the embodiments within the claims of the present application should be included in the scope of the present invention.

1. A rotor of brushless motor including a front cover, a cylindrical casing and a magnet adhered to the inner surface of the cylindrical casing, wherein the cylindrical casing is provided with some grooves on its outside surface.

2. The rotor of brushless motor of claim 1, wherein the grooves include the ones extending in the circumferential direction of the cylindrical casing.

3. The rotor of brushless motor of claim 1, wherein the sectional shapes of the grooves in the axial direction of the cylindrical casing include triangle, trapezium or rectangle.

4. The rotor of brushless motor of claim 1, wherein the grooves include some continuous helical ones and some separated annular ones.

5. A brushless motor including a rotor, a stator and a rotating shaft, wherein the rotor includes a front cover, a cylindrical casing and a magnet adhered to the inner surface of the cylindrical casing, and the stator comprises silicon steel sheets and a rear cover; wherein the cylindrical casing of the rotor is provided with some grooves on its outside surface.

6. The brushless motor of claim 5, wherein the grooves include the ones extending in the circumferential direction of the cylindrical casing.

7. The brushless motor of claim 5, wherein the sectional shapes of the grooves in the axial direction of the cylindrical casing include triangle, trapezium or rectangle.

8. The brushless motor of claim 5, wherein the grooves include some continuous helical ones and some separated annular ones.
